(19) United States
(12) Patent Application Publication
(10) Pub. No.: US 2007/0153090 A1
(43) Pub. Date: Jul. 5, 2007

(54) SYSTEM FOR OPERATING A PLURALITY OF MOBILE IMAGE CAPTURING DEVICES

(75) Inventors: Yuen Khim LIOW, Singapore (SG); Siang Thia GOH, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 11/681,140

(22) Filed: Mar. 1, 2007

Related U.S. Application Data
(63) Continuation of application No. PCT/SG05/00297, filed on Aug. 31, 2005.
(60) Provisional application No. 60/606,243, filed on Sep. 1, 2004.

(51) Int. Cl. H04N 5/225

(52) U.S. Cl. 348/207.99

(57) ABSTRACT

A system for operating a plurality of mobile image capturing devices, the system comprising: a first image capturing device comprising a transmission module for transmission of an instruction from the first image capturing device to at least one other image capturing device, the transmission being over a wireless medium; the instruction causing each image capturing device to capture an image at a predetermined synchronization.

### CROSS-REFERENCE TO RELATED APPLICATIONS

This application is a continuation of international application, PCT/SG2005/000297, with an international filing date of Aug. 31, 2005 and which designates the United States, and which claims the benefit of and priority to U.S. Provisional Patent Application Ser. No. 60/606,243, filed on Sep. 1, 2004, which is incorporated herein by reference in its entirety.

### TECHNICAL FIELD

The invention concerns a system for operating a plurality of mobile image capturing devices.

### BACKGROUND OF THE INVENTION

In 2004, approximately 18% of mobile phone users own a phone with an integrated camera (camera phones). Increasingly, new mobile phone models provide an integrated camera. The camera in a camera phone usually comprises a Charge-Coupled Device (CCD) or Complementary Metal Oxide Semiconductor (CMOS) image sensor.

Camera phones have allowed users to capture images they would not otherwise capture. These include taking pictures which help police capture criminals, taking pictures of clothes or other items to discuss with friends before purchasing, and capturing images while on the scene to contribute to a news story. Users carry their mobile phone with them more often than a digital camera or digital video camera because mobile phones have become an essential communications device. Camera phones also generally tend to be more compact than digital cameras or digital video cameras. Also, camera phones provide other standard features such as a calculator, calendar, reminders and an alarm clock.

However, there are some instances where an image captured by a camera phone is inadequate and does not convey the significance of the moment.

### SUMMARY OF THE INVENTION

In a first preferred aspect, there is provided a system for operating a plurality of mobile image capturing devices, the system comprising:
a first image capturing device comprising a transmission module for transmission of an instruction from the first image capturing device to at least one other image capturing device, the transmission being over a wireless medium;
the instruction causing each image capturing device to capture an image at a predetermined synchronization.

The image capturing devices may capture the image simultaneously or within a predefined time limit. Preferably, the predefined time limit is not longer than one second between the fastest image capture time and the slowest image capture time.

The system may operate in a client/server environment where the first image capturing device is the server and the at least one other image capturing device is the client. Alternatively, the system may operate in a peer-to-peer environment where all the image-capturing devices are able to transmit the instruction.

The instruction may be transmitted on depression of a shutter release on the first image-capturing device.

The at least one other image capturing device may comprise a receiver module to receive the instruction transmitted from the transmission module of the first image capturing device.

In a second aspect, there is provided a method for operating a plurality of mobile image capturing devices, the method comprising:
transmitting an instruction from a first image capturing device to at least one other image capturing device over a wireless medium;
the instruction causing the image capturing devices to capture an image at a predetermined synchronization.

The image capturing devices may capture a series of images in the form of a video stream. The video stream may contain audio information if a microphone is in use.

Images that are captured at approximately the same time by each image-capturing device may be associated with each other.

A time value may be associated with each captured image to enable synchronization of the captured images later. The time value may be a time stamp to record the time the image was captured.

As an initial step, the first image capturing device may transmit a first signal to the at least one other image capturing device to cause transmission of a response signal that includes identification information of each image capturing device. The response signal may include the load time for each image-capturing device to load its image capture application.

The first signal may instruct the image capturing devices to load its image capture application. Each image-capturing device may indicate that its image capture application is loaded and is ready to capture an image. The indication may be a visual indication, audio indication or a status report delivered to the first image-capturing device. The status report may be dynamically updated.

If latency exists between the image capturing devices, a time delay module may be provided to compensate for the latency. This ensures that the images captured by the image capturing devices are captured at the same time, more precisely.

A timer module may be provided to commence capture of an image after a predetermined amount of time has elapsed after the instruction is transmitted. The timer module may co-ordinate the timing with the image capture application of the device, if one is present.

The image-capturing device may be a digital camera or a digital video camera. The image-capturing device may be integrated with another device. The at least one other image capturing device may include a mobile telephone with an integrated digital camera, a notebook computer with an attached web cam or a Personal Digital Assistant (PDA) with an integrated digital camera.

Where there are a plurality of other image capturing devices, the first image-capturing device may transmit the first signal or instruction to each of the plurality of other image capturing devices at the same time. The first signal or instruction may be broadcast in a predetermined frequency band. Preferably, a communication channel is selected to prevent inadvertent activation of image capturing devices not part of the plurality of image capturing devices. Alternatively, the instruction may be sequentially transmitted from one image-capturing device to at least one other image-capturing device.

The instruction may be transmitted via an encoded radio signal. The instruction may be transmitted via infrared signal.

The first image capturing device and the at least another image capturing device may communicate via Bluetooth, IEEE 802.11b (Wi-Fi), Wi-Max or wireless USB.

To ensure predictable performance, a compatibility module may be provided to ensure that compatible hardware and software is being used. If non-compatible hardware or software is detected, an alarm is raised.

To improve accuracy during later synchronization, a synchronization module may be provided to synchronize internal clocks of the devices prior to capturing an image.

A control module may be provided to enable central control of the capture settings of the image capturing devices. The capture settings may include the image size, contrast and brightness settings, landscape or portrait image orientation, or whether a flash is activated.

A preview module may be provided to display a preview of the images to be captured by the image capturing devices.

The control module and preview module may be provided only on the first image-capturing device.

The transmission module may be provided in a software program or hard-wired as an electronic circuit.

In a third aspect, there is provided a mobile image capturing device of a group of mobile image capturing devices, the device comprising:
a transmission module for transmission of an instruction to at least one other image capturing device, the transmission being over a wireless medium;
the instruction causing the image capturing device and the at least one other image capturing device to capture an image at a predetermined synchronization.

In a fourth aspect, there is provided a mobile image capturing device of a group of mobile image capturing devices, the device comprising:
a receiver module to receive an instruction transmitted from the transmission module of at least one other image capturing device, the transmission being over a wireless medium;
the instruction causing the image capturing device and the at least one other image capturing device to capture an image at a predetermined synchronization.

Advantageously, multiple image capturing devices allow multiple angles of an object or scene to be captured. Also, redundancy is provided in the event one or more image capturing devices fail.

The predetermined synchronization may be one of: at the same time, sequentially based on a time delay, and sequentially based on a number of frames delay.

### BRIEF DESCRIPTION OF THE DRAWINGS

An example of the invention will now be described with reference to the accompanying drawings, in which:

FIG. 1 is a perspective view of a preferred embodiment of a mobile image-capturing device in the form of a mobile phone;

FIG. 2 is a block diagram of the structure of the mobile phone of FIG. 1;

FIG. 3 is a block diagram of the system; and

FIG. 4 is a process flow diagram of the system.

### DETAILED DESCRIPTION OF THE DRAWINGS

The drawings and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, and data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

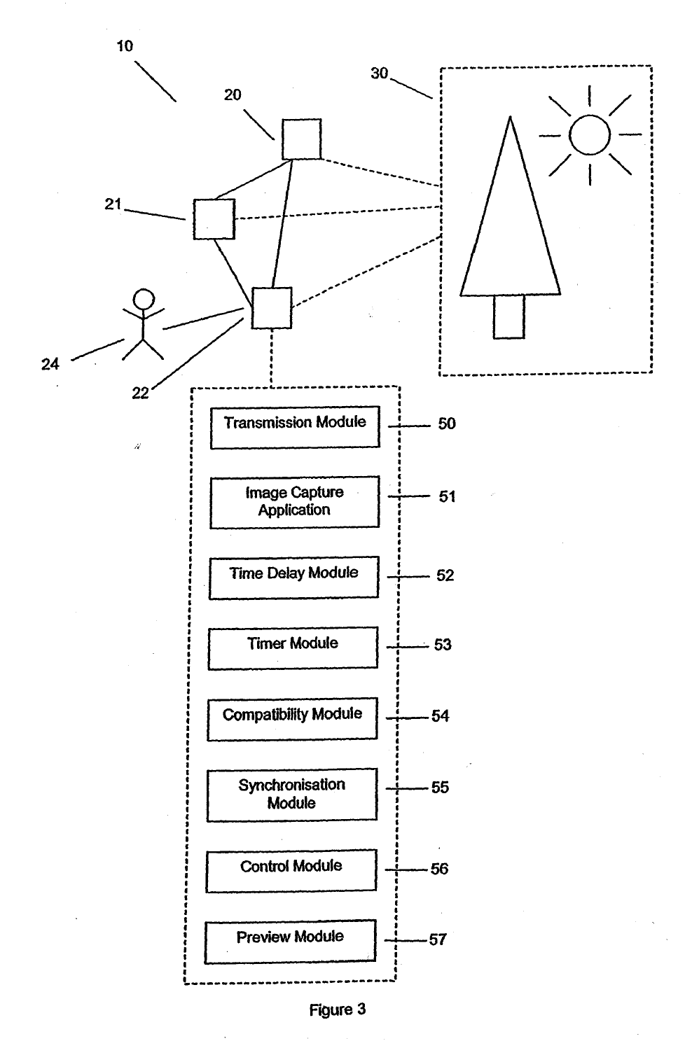

Referring to FIG. 3, a system 10 for operating a group of image capturing devices 20, 21, 22 is provided. Image capturing devices 20, 21, 22 include mobile phones with integrated digital cameras, and digital cameras including digital still and video cameras all with telecommunication modules, web cams mounted on computers, or Personal Digital Assistants (PDAs) with integrated digital cameras. These image capturing devices 20, 21, 22 are able to capture an image 30 or a video clip, digitally, in high resolution. For example, resolutions ranging from one to six megapixels per image 30. The captured image 30 is preferably compressed in JPEG format (MPEG-2 in the case of video) and is assigned a filename and a creation/modification date.

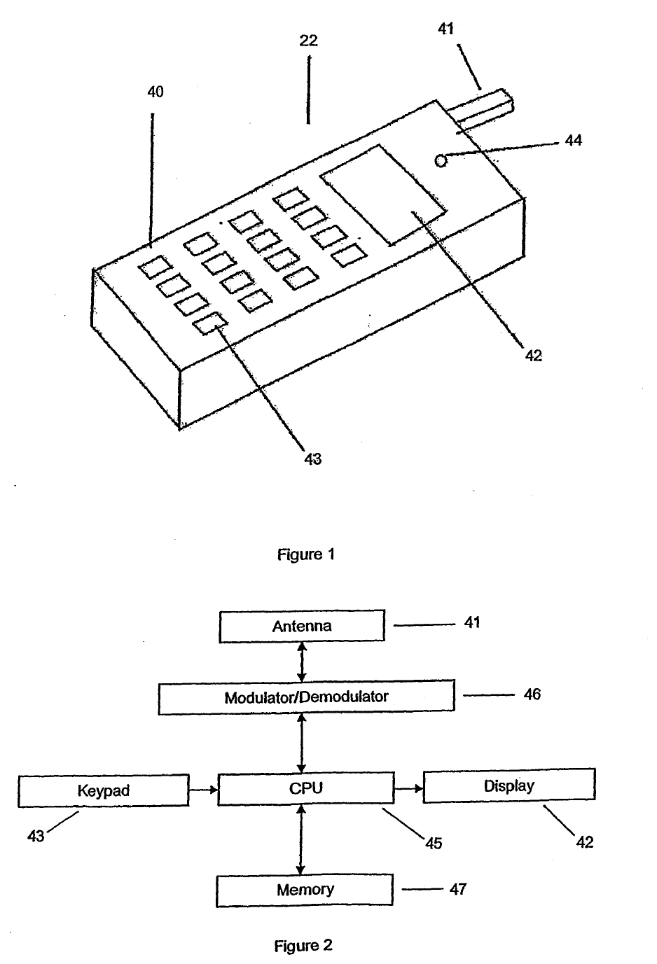

FIG. 1 depicts a mobile image capturing device 20, 21, 22 in the form of a camera-enabled mobile phone 22, suitable for use in the system 10. The phone 22 has a casing 40, an antenna 41, a display 42, a keypad 43, and a camera lens 44. The electronic structure of the mobile phone 22 is shown in FIG. 2. The antenna 41 is operatively connected to a central processing unit (“CPU”) 45 by a modulator/demodulator 46. Keypad 43 is also operatively connected to CPU 45, as is display 42. Relevant controllers/device drivers for keypad 43 and display 42 may be in CPU 45 and/or the keypad 43 and display 42 respectively. A memory 47 is also operatively connected to the CPU 45.

The system 10 is able to operate in a client/server or peer-to-peer environment. One image-capturing device acts as a master image-capturing device 22 operated by the user 24. It is able to remotely control the other image capturing devices 20, 21 in the group. The system 10 generally comprises: a transmission module 50, image capture application 51, time delay module 52, timer module 53, compatibility module 54, synchronization module 55, control module 56 and a preview module 57.

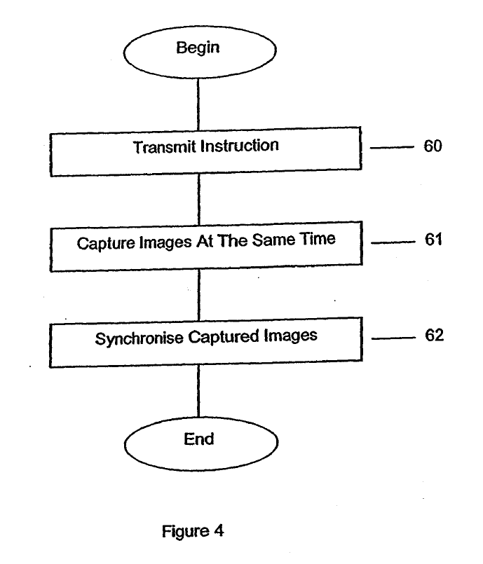

Referring to FIG. 4, the transmission module 50 transmits 60 an instruction from the master device 22 to all the image capturing devices 20, 21. This transmission occurs wirelessly and is broadcast in a predetermined frequency band depending on the protocol or standard used. The user selects or the transmission module 50 automatically determines an available communication channel for communicating with all devices 20, 21, 22. This prevents inadvertent activation of image capturing devices that are not part of the present group. Alternatively, the instruction can be sequentially transmitted from one image-capturing device 20 to another 21. Bluetooth enabled devices are increasingly popular. To enjoy widespread market penetration, the preferred embodiment of the system 10 transmits the instruction via the Bluetooth protocol. However, it is possible to transmit the instruction via IEEE 802.11b, Wi-Fi Max, wireless USB or other wireless protocol. It is also possible to transmit the instruction via an infrared signal from the master device 22 to the image capturing devices 20, 21, if line of sight between devices 20, 21, 22 is available. Other open or proprietary standards and protocols are equally applicable.

On receiving the instruction, the image capturing devices capture 61 an image 30 in accordance with a predetermined and transmitted synchronization. Synchronization may be at the same, sequentially based on a time delay, or sequentially based on a number of frames delay. The phrase “at the same time” includes simultaneously and a small tolerance range for image capture by all the devices 20, 21 to occur no longer than one second. Images that are captured at approximately the same time by each image-capturing device or sequentially are associated with each other. The association is implemented by time stamping each image. Captured images which have the same time stamp or sequential time stamps are associated with one another. Time stamping each image also allows for scope of searching through images during post processing. It also assists in displaying multiple images, and determining what images are to be displayed, where they are to be displayed, and when they are to be displayed.

Another possible association scheme is to stamp each captured image 30 with an incremental sequence number. If captured images 30 share the same sequence number, they are associated with one another. Associating the captured image 30 at the time they are captured makes it easier to synchronize 62 the images later. For example, in a digital photo album, a user 24 may organize it in such a manner that all related captured images 30 are presented together. For a birthday, the person blowing out the candles on their birthday cake may have images 30 of him or her blowing out the candles from multiple camera positions at that specific moment in time. This provides a superior visual experience in contrast to merely a single image of that moment.

Also, if one of the image capturing devices 20, 21, 22 were to fail, at least an image is captured by an operational device and not omitted entirely. Sometimes, certain camera angles are not ideal or may become obstructed depending on the circumstances. Having multiple devices 20, 21, 22 ensures that a critical moment is captured. For example, at a football match, if a player is on the other side of the field it becomes more ideal to capture their image 30 from a closer position. Instead of moving from the user's 24 current position, the user 24 is able to capture, at the same time, an image 30 of the player using multiple devices 20, 21, 22 placed at different positions around the field. Later, the user 24 is able to select the best images to keep. The selection of images 30 may be based on the best lighting conditions, the closeness of the image 30, the sense of action conveyed by the image 30, or the clarity of the image 30.

To improve efficiency, the master device 22 initially transmits an initialization signal to the image capturing devices 20, 21. In response to receiving the initialization signal, the image capturing devices 20, 21 transmit a response signal that includes information to identify themselves. The response signal also includes the load time expected for each of the other image capturing devices 20, 21. That is, how much time it takes to start up and execute its image capture application 51 before it is ready to capture images 30. Most image capturing devices 20, 21, 22 are generally provided with an image capture application 51 on non-volatile memory to control the capture of images 30. For example, the Sony Clie PEG-NZ90 PDA has the Clié handheld Camera S application to control image capture.

The initialization signal instructs the image capturing devices 20, 21 to load its image capture application 51. When ready, each image capturing device 20, 21 indicates that its image capture application 51 is loaded and is ready to capture an image 30. This indication is a status report delivered to the master device 22 for the user 24 to inspect. The report also dynamically updates as the status of each device 20, 21 changes. Conversely, the master device 22 is able to deactivate the devices 20, 21 if image capture is no longer required or foreseeable.

If latency exists between the image capturing devices 20, 21, a time delay module 52 is provided to compensate for the latency. This ensures that the images 30 captured by the image capturing devices 20, 21 are captured in accordance with the required synchronization such as, for example, at the same time, with increased precision. For example, some image capture applications 51 take a longer time after triggering, to actually capture an image 30, compared to others. Reasons for this include auto-focus adjustment and how efficient the software code for the application 51 has been written. This may also allow for different human response time.

A timer module 53 is provided to commence capture of an image 30 after a predetermined amount of time has elapsed after the instruction is transmitted. For example, if the user 24 wishes to be present in the image 30 also, he or she can set a delay of twenty seconds from the time of activating the capture button before the image 30 is captured. This should provide sufficient time for him or her to take their position in the image 30. The timer module 53 co-ordinates the timing with the image capture application 51 of the device 20, 21, if one is present for the devices 20, 21. It also allows user 24 to set different time delays for different devices 20, 21.

For consistent performance, a compatibility module 54 is provided to ensure that compatible hardware and software is being used with the system 10. If non-compatible hardware or software is detected, an alarm is raised. The compatibility module 54 checks for image capturing devices 20, 21, 22 supported by the system 10 including the brand and model of the mobile phones or PDAs. Also, the module 54 checks the availability of new drivers or software required for the image capturing devices 20, 21, 22 to interact with the system 10.

To improve accuracy in matching images 30 taken in accordance with the desired synchronization, a synchronization module 55 is provided. This module 55 enables the internal clocks of the devices 20, 21 to be synchronised with each other prior to capturing an image 30. This ensures that the time stamps which are stamped on each captured image 30 will be very close or exactly the same, when the images 30 are captured at the same time, or in accordance with the instructed delay.

For increased user friendliness, the master device 22 comprises a control module 56 to enable centralised control of the capture settings of all the image capturing devices 20, 21 22 in the group. The capture settings include the size of the captured image, contrast and brightness settings, landscape or portrait image orientation, or whether a flash is activated. Also, the master device 22 comprises a preview module 57 to display a preview of the images 30 to be captured by the image capturing devices 20, 21, 22. The user 24 is able to determine whether any of the image capturing devices 20, 21, 22 need to be re-positioned to a more ideal location.

For certain situations, triggering to collect multiple images from each image capturing devices 20, 11 may start shortly before an event—for example, a penalty kick in a football game. When the buffer for one or both of image capturing devices 20, 21 is full, it will loop back to the start. Such a sequence may also be for a preset number of frames, or for a predetermined time period.

Upon post processing taking place, which segment of the images from each image capturing devices 20, 21 are to be used can be decided, and synchronization can take place, using frame numbers and/or time stamps.

Although still images have been described, it is possible to capture video clips from multiple image capturing devices 20, 21. Videos may contain audio if a microphone is present with or connected to one of the image capturing devices 20, 21, 22. If more than one microphone is present, the audio can be recorded and multiplexed into separate channels to provide a surround sound effect during playback.

Although it has been described that images are captured at the same time by the image capturing devices 20, 21, it is acceptable to have a small time variance between the capture of the image by each image capturing device 20, 21. Preferably, the tolerated time variance is no more than one second.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A system for operating a plurality of mobile image capturing devices, the system comprising:
a first image capturing device comprising a transmission module for transmission of an instruction from the first image capturing device to at least one other image capturing device, the transmission using wireless technology;
the instruction causing each image capturing device to capture an image at a predetermined synchronization; and
a compatibility module to ensure compatibility of hardware and software in the system, wherein each image capturing device communicates with at least one other image capturing device using wireless technology.

2. A system as claimed in claim 1, wherein the predetermined synchronization is selected from the group consisting of: at the same time, sequentially based on a time delay, and sequentially based on a number of frames delay.

3. The system according to claim 1, wherein the system operates in a client/server environment where the first image capturing device is the server and the at least one other image capturing device is the client.

4. The system according to claim 1, wherein the system operates in a peer-to-peer environment where all image capturing devices are able to transmit the instruction.

5. The system according to claim 1, wherein the instruction is transmitted on depression of a shutter release on the first image capturing device.

6. The system according to claim 1, further comprising a time delay module to compensate for latency existing between the image capturing devices.

7. The system according to claim 1, wherein the first image capturing device is a mobile device with a telecommunications module and comprises a digital camera or a digital video camera.

8. The system according to claim 7, wherein the at least one other image capturing device includes a mobile telephone with an integrated digital camera, a computer with an attached web cam, or a Personal Digital Assistant (PDA) with an integrated digital camera.

9. The system according to claim 1, wherein the wireless technology is selected from the group consisting of: encoded radio signal, Bluetooth, IEEE 802.11b (Wi-Fi), Wi-Max, wireless USB, and infrared signals.

10. The system according to claim 1, further comprising a control module to enable central control of the capture settings of the image capturing devices and wherein the capture settings include at least one of the image size, contrast and brightness settings, landscape or portrait image orientation, or whether a flash is activated.

11. The system according to claim 1, further comprising a preview module on the first image capturing device to display a preview of the images to be captured by the at least one other image capturing devices.

12. A method for operating a plurality of mobile image capturing devices, the method comprising:
checking compatibility of the plurality of mobile image capturing devices;
transmitting an instruction from a first image capturing device to at least one other image capturing device using wireless technology; the instruction causing the image capturing devices to capture an image at a predetermined synchronization.

13. The method of claim 12, wherein the predetermined synchronization is selected from the group consisting of: at the same time, sequentially based on a time delay, and sequentially based on a number of frames delay.

14. The method according to claim 12, wherein a time value is associated with each captured image to enable synchronization of the captured images later.

15. The method according to claim 12, further comprising an initial step of: transmitting a first signal from the first image capturing device to the at least one other image capturing device to cause transmission of a response signal that includes identification information of each image capturing device.

16. The system according to claim 12, wherein the wireless technology is selected from the group consisting of: encoded radio signal, Bluetooth, IEEE 802.11b (Wi-Fi), Wi-Max, wireless USB, and infrared signals.

17. A mobile image capture device adaptable to capture images in conjunction with at least one other image capture device to form a plurality of image capture devices, the device comprising:
a telecommunications module; and
a transmission module configured to transmit using wireless technology an image capture instruction to the at least one other image capture device, said instruction causing each image capturing device in the plurality to capture an image at a predetermined synchronization; wherein the device is configured to determine using wireless technology that the at least one other mobile image capture device is available to capture images.

18. The device as recited in claim 17 wherein the mobile image capture device is a mobile phone with an integrated digital camera or integrated digital video camera.

19. The device as recited in claim 17 further comprising a preview module to display on the mobile image capture device a preview of an image to be captured by the at least one other image capture device.

20. The device as recited in claim 17 wherein the predetermined synchronization is based at least in part on compensating for the latency of the image capture devices in the plurality.

21. The device as recited in claim 17 further comprising a compatibility module to ensure compatibility of hardware and software in the group of mobile image capturing devices.
